(19) United States
(12) Patent Application Publication
(10) Pub. No.: US 2021/0118039 A1
(43) Pub. Date: Apr. 22, 2021

(54) MODIFICATION OF AN ONLINE TRANSACTION THAT IS INITIATED AND COMPLETED VIA A SINGLE USER INPUT ACTION

(71) Applicant: Skipify, Inc., Danville, CA (US)

(72) Inventors: Erythean MARTIN, Danville, CA (US); Rashad ITANI, San Jose, CA (US); Jeremiah ANDERSON, Los Altos, CA (US)

(73) Assignee: Skipify, Inc., Danville, CA

(21) Appl. No.: 17/073,348

(22) Filed: Oct. 17, 2020

Related U.S. Application Data
(60) Provisional application No. 62/916,801, filed on Oct. 18, 2019.
(60) Provisional application No. 62/916,802, filed on Oct. 18, 2019.

(51) Int. Cl. G06Q 30/06; G06Q 20/08; G06Q 20/42; G06F 16/955; G06F 16/958; G06F 21/60; G06F 3/0482

(52) U.S. Cl. CPC G06Q 30/0635; G06Q 20/085; G06Q 20/42; G06F 16/955; G06Q 20/227; G06F 21/602; G06F 3/0482; G06Q 30/0623; G06Q 2220/00; G06F 16/958

(57) ABSTRACT

An online purchase network enables an online purchase with a merchant to be modified after checkout when the online purchase is initiated via a single input action by a user and before the online purchase is processed by online merchant. Once an online checkout process for a particular purchase has been initiated with the single input action by the user, such as a mouse click or screen tap, the user is provided a time interval in which to modify information associated with the purchase before the online purchase is processed by the online merchant. Such information may include product information, personal-identifying information, credit card information, shipping information, and the like.

### CROSS-REFERENCE TO RELATED APPLICATION

The present application claims the benefit of U.S. Provisional Application No. 62/916,801, filed Oct. 18, 2019 and U.S. Provisional Application No. 62/916,802, filed Oct. 18, 2019. The aforementioned U.S. Provisional applications, including any appendices or attachments thereof, is hereby incorporated by reference in its entirety.

### BACKGROUND

Unless otherwise indicated herein, the approaches described in this section are not prior art to the claims in this application and are not admitted to be prior art by inclusion in this section.

The development of e-commerce has enabled merchants and manufacturers to electronically combine advertising and presentation of products and services with receiving orders for such products directly from a customer. Thus, manufacturers and/or sellers of products and services can both describe a product to a customer and receive electronically transmitted orders from the customer for the product, for example, through an Internet web site. In this way, e-commerce facilitates the selection and ordering process, greatly increasing sales.

However, there are still sources of friction in e-commerce that impede the completion of an online sale. For example, checkout methods available to online shoppers typically include manually filling out multi-page, multi-field forms, a process that is sufficiently time-consuming that some online shoppers are discouraged from completing a transaction. In addition, manual form completion is subject to human error, which can result in shipping and/or billing issues that create significant customer dissatisfaction with the online shopping experience.

To further reduce friction in online shopping, certain payment facilitation tools, such as PayPal™, Apple Pay™, Google Pay™, and Amazon Pay™, have been designed to reduce manual field entry. However, to complete an online transaction, such payment facilitation tools still require additional login steps, transfer of a shopper onto a separate website associated with the payment facilitator site, and/or payment and shipping confirmation actions. Such additional actions and Internet redirections can cause delays and other friction that lower the rate of completed transactions by the online shopper. In addition, significant engineering effort is required on the part of the merchant to enable such automation for each individual payment facilitation tool, which can be problematic for smaller merchants.

Furthermore, while conventional payment facilitation tools enable an order to go through a complete online checkout process at a specific merchant with a single user input (such as a single mouse click or touchscreen tap), subsequent changes to such an order is more involved. Generally, the online shopper must perform a series of additional steps, such as logging in to the merchant website and/or navigating within the merchant website to a list of existing orders, selecting the appropriate order, canceling the order, and repeating the online selection process with the new product, shipping, and/or purchasing information. Such additional actions add friction to the order-modification process, can be time-consuming and frustrating for the online shopper, and can create customer dissatisfaction with a particular online merchant.

### SUMMARY

In accordance with at least some embodiments of the present disclosure, an online purchase network enables an online purchase with a merchant to be modified after checkout when the online purchase is initiated via a single input action by a user and before the online purchase is processed by online merchant. That is, once an online checkout process for a particular purchase has been initiated with the single input action by the user, such as a mouse click or screen tap, the user is provided a time interval in which to modify information associated with the purchase before the online purchase is processed by the online merchant. Such information may include product information, personal-identifying information, credit card information, shipping information, and the like.

Further embodiments include a non-transitory computer-readable storage medium comprising instructions that cause a computer system to carry out one or more of the above methods, as well as a computer system configured to carry out one or more of the above methods.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

FIG. 1 is a block diagram of an online transaction network, according to one or more embodiments of the present invention.

FIG. 2 illustrates a graphical user interface that displays a web page of a merchant website, according to an embodiment.

FIG. 3 illustrates a graphical user interface that displays a confirmation page on a merchant website, according to an embodiment.

FIG. 3 is a flowchart illustrating the steps performed by the online transaction network of FIG. 1 as part of a user registration process, according to various embodiments.

FIG. 4 is a flowchart illustrating the steps performed by the online transaction network of FIG. 1 as part of an online transaction process, according to various embodiments.

FIG. 5 is a block diagram illustrating a payment method storage system implemented within the online transaction network of FIG. 1, according to various embodiments.

FIG. 6 is a flowchart illustrating the steps performed by the online transaction network of FIG. 1 as part of a payment method registration process, according to various embodiments.

FIG. 7 is a flowchart illustrating the steps performed by the online transaction network of FIG. 1 as part of an online payment process, according to various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the disclosure, as generally described herein, and illustrated in the figures, can be arranged, substituted, combined, and designed in a wide variety of different configurations, all of which are explicitly contemplated and make part of this disclosure.

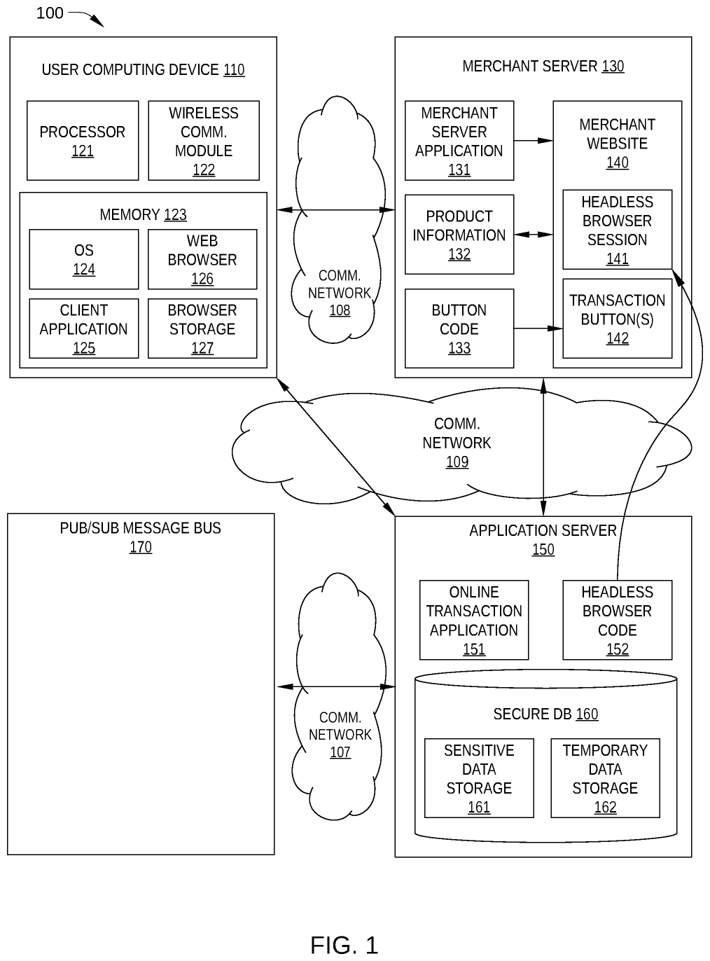

FIG. 1 is a block diagram of an online transaction network 100, according to one or more embodiments of the present invention. As described below, online transaction network 100 enables checkout for an online purchase on a merchant website 140 to be initiated and completed from a user computing device 110 via a single input action by a user, such as a mouse click or screen tap. In the embodiments, such checkout is completed even when user credit card information and/or shipping information is not stored by or otherwise available to merchant website 140. Online transaction network 100 further enables a user to modify one or more details of the online purchase after checkout has been initiated and before the online purchase is processed by a merchant server 130.

Online transaction network 100 includes user computing device 110, merchant server 130, an application server 150, and, in some embodiments, a publish/subscribe (pub/sub) messaging bus 170. User computing device 110 is communicatively coupled to merchant server 130 and/or application server 150 by a communication network 108, merchant server 130 is communicatively coupled to application server 150 by a communication network 109, and application server 150 is communicatively coupled to pub/sub messaging bus 170 by a communication network 107. Communication network 107, communication network 108, and communication network 109 can each include a wireless local area network (WLAN), a cellular network, a wired communication network (such as a local area network), or any combination thereof. Furthermore, while user computing device 110 is shown in FIG. 1 to be communicatively coupled to merchant server 130 by communication network 108 and to application server 150 by communication network 109, in other embodiments, one or more additional communication networks may also be employed to communicatively couple user computing device 110, merchant server 130, application server 150, and/or pub/sub messaging bus 170, such as the Internet, among others.

In some embodiments, a WLAN included in communication network 108 enables compatible devices to connect to the Internet, either via a wired connection or a wireless access point, or “hotspot.” For example, in some embodiments, the WLAN is a WiFi network that includes one or more devices based on the Institute of Electrical and Electronics Engineers (IEEE) 802.11 standard. Thus, in such embodiments, any suitably configured wireless communication device that can connect to the WLAN, such as a smartphone or electronic tablet with WiFi capability, can perform data transfer to and from the Internet. Similarly, a cellular network included in communication network 108 enables two-way wireless communication with wireless subscriber terminals, such as user computing device 110 when user computing device 110 is configured as a smartphone.

User computing device 110 can be any technically feasible and network-connected computing device. For example, user computing device 110 can be a desktop computer, laptop computer, smartphone, personal digital assistant (PDA), tablet computer, or any other type of computing device that is configured to receive input, process data, and display images, and is suitable for practicing one or more embodiments of the present invention. Thus, user computing device 110 is configured to execute a client application 125, an operating system 124, a web browser 126, and/or other software applications. In addition, user computing device 110 is configured to communicate with merchant server 130, for example via a web browser 126.

To that end, in some embodiments, user computing device 110 includes a processor 121, a wireless communication module 122, and a memory 123. Processor 121 may be any suitable processing unit implemented as a central processing unit (CPU), an application-specific integrated circuit (ASIC), a field programmable gate array (FPGA), any other type of processing unit, or a combination of different processing units. Wireless communication module 122 may be any suitable electronics package and or chipset configured to enable wireless communication with communication network 108. Thus, in some embodiments, wireless communication module 122 includes cellular capability and WiFi capability, among others. Alternatively or additionally, in some embodiments, wireless communication module 122 includes Bluetooth capability. Alternatively or additionally, in some embodiments, user computing device 110 includes a network interface controller or other computer hardware component that connects user computing device 110 to communication network 108. Memory 123 can include any suitable volatile and/or nonvolatile memory (e.g., random-access memory (RAM), read-only memory (ROM), flash memory, a magnetic hard drive, etc.), and is configured to store instructions, data, a client application 125, an operating system (OS) 124, and/or web browser 126, etc. In some embodiments, memory 123 includes browser storage 127.

Client application 125 is a computer program designed to run on user computing device 110. Client application 125 is loaded on user computing device 110 and enables interactions with application server 150 and the storage of certain payment method information, according to embodiments described herein. OS 124 supports the functions of processor 121, including scheduling tasks and sending commands to client application 125, memory 123, and wireless communication module 122, managing the power state of user computing device 110, initiating execution of applications on processor 121, managing sockets and TCP connections, and the like. For example, in some embodiments, OS 124 is configured to facilitate the execution of web browser 126, and/or other software applications.

Merchant server 130 is configured to enable online transactions with a particular online merchant. Generally, merchant server 130 can be any entity or entities that is/are separate from and can be accessed by client device 110 via communication network 108, such as via web browser 126. Merchant server 130 can be implemented as a computing device, an application running on an instance of virtual machine, and the like. For example, merchant server 130 can be a host computing device or web host service configured to provide access to and/or generate a merchant website 140. Thus, in some embodiments, merchant server 130 includes and/or executes a merchant server application 131 that generates merchant website 140. In some embodiments, merchant server further includes product information 132 and executes a button code 133 that is configured to implement certain embodiments. In some embodiments, button code 133 incorporates one or more transaction buttons 142 on merchant website 140. In some embodiments, transaction buttons 142 incorporated by button code 133 on merchant website 140 include a “buy now” button, a “click to purchase” button, and/or the like. Alternatively or additionally, in some embodiments, transaction buttons 142 incorporated by button code 133 on merchant website 140 include an “edit order” button. In some embodiments, button code 133 receives unique product-level information from merchant website 140 when user device 126 is connected to merchant website 140 via web browser 126. Further, in some embodiments, button code 133 can track user actions to finalize product information to be used in an online transaction, such as product, size, color, etc.

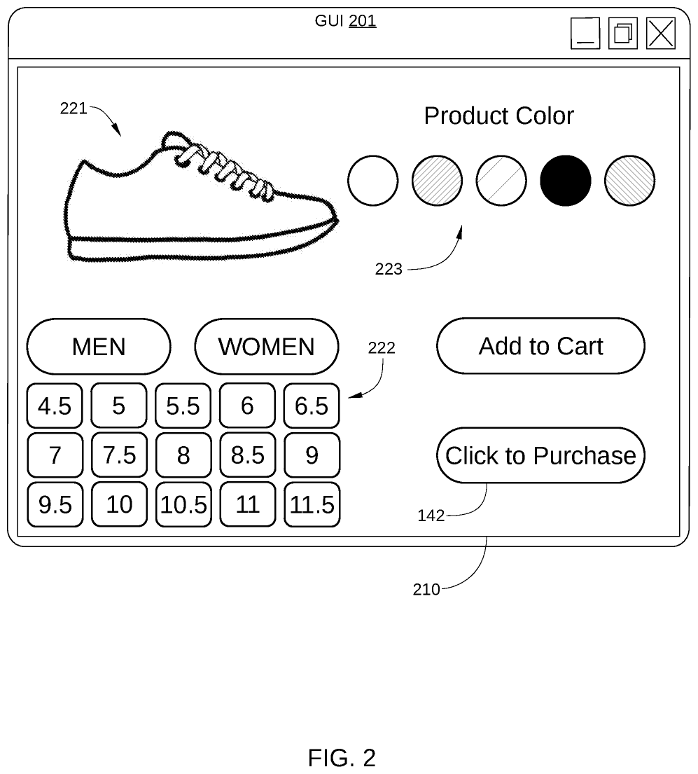

Merchant website 140 enables the display and sale of products and/or services to online shoppers. For example, in some embodiments, user computing device 110 is connected to merchant website 140 via web browser 126 in the course of online shopping. In such embodiments, a user can browse through various pages of merchant website 140 that display product information 132, select a particular product or service, and then purchase the particular product or service via transaction button 142, which is displayed with the product or service. One such embodiment is described below in conjunction with FIG. 2.

FIG. 2 illustrates a graphical user interface (GUI) 201 that displays a web page 210 of merchant website 140, according to an embodiment. As shown, web page 210 displays product information associated with one or more specific products or services available from merchant website 140. For example, in the embodiment illustrated in FIG. 2, the product information displayed includes an image 221 of a particular product, available sizes 222 of the particular produce, a menu 223 of available colors, and transaction button 142. As shown, in FIG. 2 transaction button 142 is implemented as a “click to purchase” button, which initiates an online checkout process for purchase of a particular product in response to a single input action by a user, such as a mouse click or screen tap. For example, for a user registered with online transaction network 100, the single input action from user computing device 110 causes online transaction application 151 running remotely from user computing device 110 to initiate and complete the online checkout process with merchant website 140 with no further input from the user. It is noted that, from the point of view of a user, after performing the single input action, the online checkout process appears to be complete. However, according to various embodiments, the online checkout process is not actually completed until certain information is transmitted to merchant server 130, such as product information associated with the online checkout process, billing information associated with the online checkout process, and/or shipping information associated with the online checkout process.

In some embodiments, transaction button 142 is displayed on web page 210 whenever a user device that is registered with online transaction network 100 displays web page 210. In other embodiments, transaction button 142 is displayed in response to a particular product or service associated with web page 210 being selected via a user device that is registered in online transaction network 100. In either case, according to various embodiments described herein, when a user performs an input action via transaction button 142, an online transaction for purchasing the selected product is implemented with no further actions of the part of the user.

The input action via transaction button 142 can be any suitable input action. For example, in an embodiment, the single input action performed by the user can be selection of transaction button 142 via a mouse click of user computing device 110. Alternatively or additionally, the single input action can include the highlighting and/or selection of transaction button 142 by any other technically feasible approach, such via a previously programmed hot key. In one such embodiment, the single input action can include the highlighting of transaction button 142 with a first key input (such as depression of a tab key until transaction button is highlighted) and selection of transaction button 142 with a second key input (such as depression of a space bar key or a carriage return key). Thus, in some embodiments, the single input action may include the performance of multiple key strokes that enable the selection of transaction button 142. In each case, once the user performs the single input action, the online transaction is then completed without further inputs by the user.

In the embodiments, manual data entry into one or more pages of multi-field forms is not performed by the user to complete the online transaction, such as credit card information, personal identifying information (PII), other billing information, shipping information, and the like. In addition, in the embodiments, the user is not directed to a payment facilitation tool or website for an abbreviated purchase confirmation process to be completed by the user. In conventional pay facilitator tools and services, a user may be required to login to an account that the user has established with the payment facilitator website, confirm payment information, and/or confirm shipping information before a particular online transaction is completed by the payment facilitator tool or service. The payment facilitator then charges the user and subsequently redistributes payment to merchant website 140 via an automated clearing house or other transaction, adding complexity to the process of completing the online transaction. Further, in the embodiments, the user is not required to login to an account associated with merchant website 140 to complete the online transaction. Thus, the online transaction can be completed by a user via transaction button 142 even when the user has not visited merchant website 140 before and/or has not established any sort of account with merchant website 140 or provided any PII or credit card information to merchant website 140. Some examples of an online transaction network that enables a user to complete an online transaction via transaction button 142 as set forth above have been discussed in U.S. patent application Ser. No. 16/944,125, filed Jul. 30, 2020, and is incorporated herein in its entirety by reference.

In light of the above, online transaction network 100 of FIG. 1 benefits consumers by simplifying the online purchase processes for consumers, reducing the normal level of friction in the online purchasing process. Specifically, an online consumer can have a “one-click” shopping experience on merchant website 140 without establishing an account on or providing sensitive information to merchant website 140. Online transaction network 100 also benefits online merchants by enabling such merchants to more effectively compete with larger online competitors: the complexity and cost of online transactions is reduced, and, through the streamlined process associated with transaction button 142, website conversion rates for a merchant is increased. For example, the online merchant associated with merchant website 140 is not required to create a specialized product-level application programming interface (API) for merchant website 140 that programmatically identifies specific products.

GUI 201 implemented as part of a web page is illustrative only, and in some embodiments can be implemented in other channels and mediums, including but not limited to: e-mail communications and applications, text communications, messaging applications, digital advertising units and networks, and/or the like.

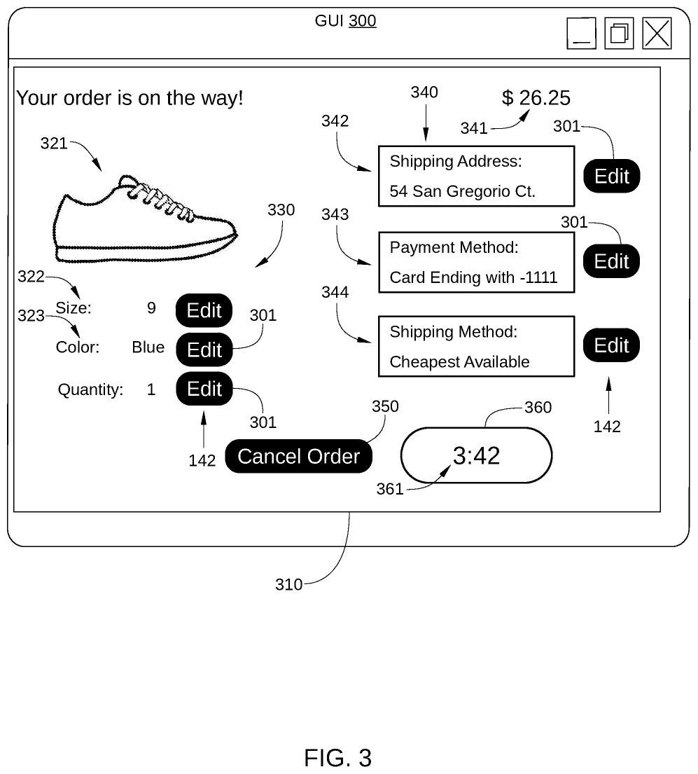

In many instances of online shopping, an online shopper may determine shortly after performing a “one-click” checkout for an online purchase that certain details of the online purchase need to be changes. For example, the online shopper, referred to herein as a “user,” may experience buyer's remorse, or may simply detect an error in the particulars of the online purchase. However, in conventional e-commerce, there is generally no ability to edit an online purchase that has been completed by a one-click checkout process. Instead, the user generally needs to cancel the order and repeat the online selection process. According to various embodiments, after an online purchase from an online merchant has been completed by a one-click checkout process, a user is provided a time interval in which to modify order information (i.e., information associated with the purchase) before the online purchase is processed by the online merchant. In such embodiments, during the time interval, a confirmation page user interface is presented to the user that enables modifications to be made to some or all portions of the order information associated with the current online purchase. One such embodiment is described below in conjunction with FIG. 3.

FIG. 3 illustrates a graphical user interface 300 that displays a confirmation page 310 of merchant website 140, according to an embodiment. In some embodiments, online transaction application 151 causes user computing device 110 to present confirmation page 310 in response to a user input via a click-to-purchase button, a buy-now button, or similar transaction button 142 in graphical user interface 201 of FIG. 2. Alternatively, button code 133 causes user computing device 110 to present confirmation page 310 in response to such a user input.

As shown, confirmation page 310 displays or otherwise presents order information associated with the online purchase completed via web browser 126 and merchant website 140 (shown in FIG. 2) via a one-click checkout process. Such order information includes product information 330 and/or billing information 340. Product information 330 includes information specific to a particular product or service associated with the online purchase completed via the one-click checkout process. In some embodiments, product information 330 includes one or more of an image 321 of the particular product, a selected size 322 of the particular product, a selected color 323 of the particular product, and/or the like. Billing information 340 includes information specific to the particular online purchase that enables the online purchase to be completed via merchant server 130, such as shipping information, credit card information, billing address, other personal identifiable information, and the like. In some embodiments, billing information 340 includes one or more of total charges 341, a shipping address 342, payment method information 343, such as a specific credit card number, a selected shipping method 344, one or more coupon codes (not shown), and/or the like.

In some embodiments, confirmation page 310 displays or otherwise presents one or more transaction buttons 142 that are configured to enable the user to modify a particular portion or field of billing information 340. As shown, in FIG. 3 such transaction buttons 142 are implemented as a “Edit” buttons 301 that each enable a user to edit or otherwise modify one or more fields of product information 330 and/or billing information 340. Alternatively or additionally, in some embodiments, transaction buttons 142 include an “Edit Order” button (not shown) that enables modification of all fields of product information 330 and/or billing information 340. In addition, in some embodiments, confirmation page 310 displays or otherwise presents a cancel order button 350 that enables the user to cancel the online purchase completed via the one-click checkout process before product information 330 and/or billing information 340 are transmitted to merchant server 130 and the online purchase is processed.

In some embodiments, confirmation page 310 includes a timeout counter 360 that displays or otherwise presents a remaining time 361 that the user has to edit or cancel the online purchase completed via the one-click checkout process. For example, in some embodiments, the time initially provided for a user to edit or cancel an online purchase before that online purchase is processed by merchant server 130 is on the order of about 2 to 5 minutes. In some embodiments, the time initially provided for a user to edit or cancel the online purchase is resettable. In such embodiments, a current remaining time for editing or canceling the online purchase is reset to the initial time when a user selects an edit button 301 or modifies a field of product information 330 and/or billing information 340.

Returning to FIG. 1, application server 150 is configured to implement certain encryption, decryption, and other operations to enable various embodiments described herein. Such operations include encryption and decryption of portions of payment method information; retrieval of encrypted portions of payment method information; receipt of payment method information from client device 110; delivery of an encrypted portion of payment method information to client device 110; causing a headless browser operation to be connected to merchant website 140; and/or informing the headless browser operation, via a messaging methodology, that an order has been placed, for example by placing order information into a pub/sub message bus to initiate an online order processing function, among others. Generally, application server 150 can be any entity that is separate from and can be accessed by client device 110 via communication network 108 and merchant server 130 via communication network 109. Thus, in some embodiments, application server 150 can be implemented as a computing device, an application running on an instance of virtual machine, and the like.

Application server 150 includes one or more of an online transaction application 151, headless browser code 152, and, in some embodiments, a secure database 160. Online transaction application 151 is configured to perform the various operations associated with application server 150 as described herein. In addition to one or more of the above-described operations of application server 150, online transaction application 151 is further configured to implement certain operations to enable modifications to be made to some or all portions of order information associated with an online checkout purchase before the online checkout process is completed by merchant server 130. In some embodiments, such operations include receiving first order information associated with an online checkout process from a user computing device; storing the first order information as provisional order information for the online checkout process; determining whether the first order information is being modified at the user computing device; in response to determining that the first order information is being modified, pausing completion of the online checkout process; receiving second order information for the online checkout process; in response to receiving the second order information, replacing the provisional order information with the second order information; and completing the online checkout process with the merchant computing device using the second order information.

Headless browser code 152 is configured to, upon execution, establish a headless browser session 141 with a specific merchant website 140 on which button code 133 is deployed and to which a user computing device 110 is connected via web browser 126. In some embodiments, headless browser code 152 is executed when web browser 126 connects to a merchant website 140 on which button code 133 is deployed. In such embodiments, client application 125 may notify online transaction application 151 that headless browser code 152 can establish headless browser 141 with merchant website 140. Headless browser session 141 is configured to receive data of the user, such as product information, that is collected by button code 133 when a user selects a specific product on merchant website 140. Headless browser code 152 is configured to, upon selection of transaction button 142 via a user input action, complete a checkout on behalf of the running user by completing the merchant checkout process with user information stored in secure database 160, payment information stored in temporary data storage 162 of secure database 160, and order information received from button code 133. Thus, headless browser code 152 can compensate for the inability of merchant website 140 to accept third-party payment information via API, identify product-level information via API, and/or allow a third party to execute a checkout process on behalf of the running user via API.

Secure database 160 may be a structured query language (SQL) compatible database or other relational database. As shown, secure database 160 is configured with sensitive data storage 161 and temporary data storage 162. In the embodiment illustrated in FIG. 1, secure database 160 is incorporated in application server 150. In other embodiments, secure database 160 can be implemented in a computing device that is separate from application server 150.

Sensitive data storage 161 is configured to store encrypted payment method information for a plurality of payment methods, where each payment method is associated with a different credit card account and user. Specifically, for a particular user and a particular payment method, sensitive data storage 161 is configured to store a first encrypted portion of payment method information and a decryption key for a second encrypted portion of the payment information. For example, in some embodiments, the first encrypted portion of payment method information includes a primary account number for a credit card account of the user and/or a card expiration date associated with the primary account number for the credit card account. It is noted that each first encrypted portion of payment method information stored in sensitive data storage 161 is encrypted with a different decryption key. As a result, unauthorized access to sensitive data storage 161 cannot yield useful sensitive information, such as primary account numbers, unless a separate decryption key has been determined for each first encrypted portion of payment method information. In addition, complete payment method information is not included in sensitive data storage 161, which further enhances the security of data stored therein. For example, only one of a primary account number and a card verification value (CVV) is stored in sensitive data storage 161 as the first encrypted portion of payment method information. In some embodiments, sensitive data storage 161 is further configured to store PII and other user information for a plurality of users, such as name, billing address, shipping address, and, in some embodiments, a preferred payment method for one or more previously visited merchant websites 140.

Temporary data storage 162 is configured to store an encrypted version of a complete set of payment method information for a particular payment method and for a particular online transaction. For example, in an embodiment, the complete set of payment method information for a particular payment method in an embodiment includes a primary account number, a CVV associated with the primary account number, and an expiration data associated with the primary account number. According to various embodiments, the encrypted version of the complete set of payment method information is deleted, erased, or otherwise removed from temporary storage 162 by headless browser code 152 upon completion of the online transaction associated with the complete set of payment method information.

In some embodiments, a user registration process is performed by online transaction network 100 to enable a particular user to subsequently initiate and complete an online transaction with a single input action at any merchant website 140 that includes button code 133. Some examples of such a user registration process have been discussed in U.S. patent application Ser. No. 16/944,125, filed Jul. 30, 2020, and is incorporated herein in its entirety by reference.

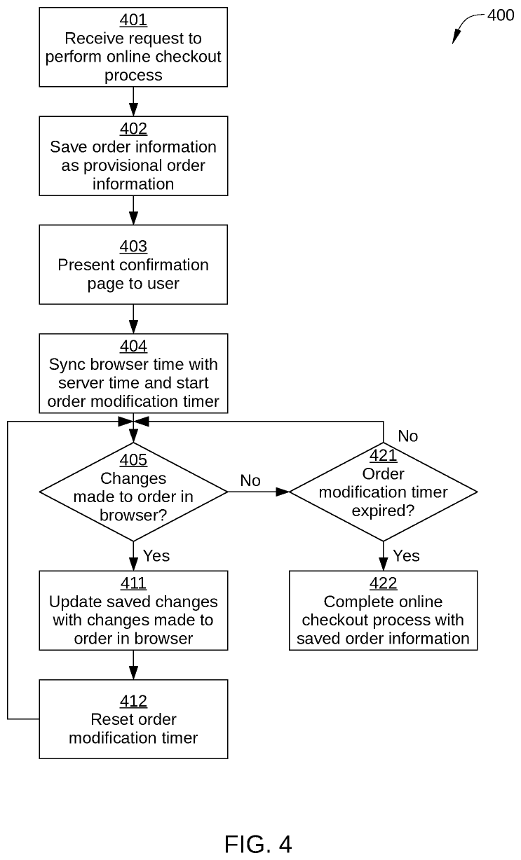

FIG. 4 is a flowchart illustrating the steps performed by online transaction network 100 as part of an online transaction process 400, according to various embodiments. Online transaction process 400 may include one or more operations, functions, or actions as illustrated by one or more of blocks 401-422. Although the blocks are illustrated in a specific order, these blocks may be performed in parallel, and/or in a different order than those described herein. Also, the various blocks may be combined into fewer blocks, divided into additional blocks, and/or eliminated based upon a specific implementation. Although the method is described in conjunction with online transaction network 100 of FIG. 1, persons skilled in the art will understand that within the scope of the present disclosure any suitably configured system can perform online transaction process 400.

Online transaction process 400 begins at step 401, where online transaction application 151 receives a request to perform an online checkout process for a particular online purchase. In some embodiments, online transaction application 151 receives the request to perform the online checkout process from web browser 126. In such embodiments, web browser 126 is running on user computing device 110 and is connected to merchant website 140, for example, via a TCP connection. In such embodiments, the request to perform the online checkout is transmitted when the user input is executed via a transaction button 142 associated with merchant website 140, such as a “purchase with one click” button or other input interface, and/or with a form in web browser 126.

In some embodiments, the request to perform the online checkout process includes order information for the online purchase and a user identification that is associated with the user of user computing device 110. In such embodiments, additional information associated with the user can be retrieved by online transaction application 151 based on the user identification, such as a particular payment method, shipping information, and the like. For example, such additional information may be stored in sensitive data storage 161 of secure database 160. In some embodiments, the order information includes product information 330. In other embodiments, the order information includes product information 330 and billing information 340.

In some embodiments, billing information 340 may include most or all billing information required for the online checkout process to be completed by merchant server 130, such as a complete credit card number and associated CVV, billing address, credit card user name, and the like. For example, in such embodiments, billing information 340 may be entered manually by the user immediately prior to requesting the online checkout process to be performed. Alternatively, in some embodiments, billing information 340 may include tokenized payment data. In such embodiments, online transaction application 151 is configured to retrieve, decrypt or otherwise access payment information based on the tokenized payment data. In such embodiments, online transaction application 151 is configured to subsequently employ the accessed payment information to complete the online checkout process with merchant server 130. Alternatively, in some embodiments, billing information 340 may include a payment method identifier that is associated with a complete credit card number and associated CVV, billing address, and credit card user name. In such embodiments, online transaction application 151 is configured to retrieve and/or decrypt billing information associated with the payment method identifier, such as a complete credit card number and associated CVV, billing address, and credit card user name. Some examples of such an online transaction application have been discussed in U.S. patent application Ser. No. 16/944,125, filed Jul. 30, 2020, and is incorporated herein in its entirety by reference.

In step 402, online transaction application 151 stores the order information included in the request to perform the online checkout process as provisional order information. Online transaction application 151 is configured to complete the online checkout process using the provisional order information if no changes are made to the order information before a predetermined time interval, e.g., 5 minutes. However, according to various embodiments described herein, if changes to the order information are detected before the predetermined time interval expires, the stored provisional order information is updated with the detected changes. Thus, order information provided for an online checkout process can be modified after an online checkout process has been requested and before online transaction application 151 actually uses the order information to complete the online checkout process with merchant server 130.

In step 403, online transaction application 151 causes web browser 126 to present a confirmation page 310 to the user on user computing device 110. Generally, confirmation page 310 enables the user to modify one or more portions of the order information associated with the online purchase, such as shipping information, billing information, quantity of a particular product to be purchased, options selected for the particular product to be purchased, and/or the like. In some embodiments, confirmation page 310 includes embedded logic that indicates to online transaction application 151 when a particular field is modified or a user input is received via a transaction button. In some embodiments, confirmation page 310 includes a current value of an order modification timer, such as timeout counter 360. The order modification timer indicates a remaining time for editing or canceling the online purchase, and is described in greater detail below.

In step 404, online transaction application 151 synchronizes browser time with the server time of application server 150 and begins an order modification timer that counts down from a predetermined time, such as 3 minutes, 5 minutes, or the like. As described below, expiration of the order modification timer causes online transaction application 151 to complete the online checkout process requested in step 401 with merchant server 130. Because browser time of web browser 126 and server time of application server 150 are synchronized, the time remaining that is displayed by web browser 126, for example via timeout counter 360, closely corresponds to the time remaining before online transaction application 151 completes the online checkout process requested in step 401 with merchant server 130. In alternative embodiments, the order modification timer is operated without synchronization of browser time with the server time of application server 150, and step 404 is not performed.

In step 405, online transaction application 151 determines whether a change has been made to order information associated with the request for the online checkout process. In some embodiments, logic embedded in confirmation page 310 can notify online transaction application 151 when a field is modified with a user input and/or when transaction button 142 receives a user input. When no change is detected, online transaction process 400 proceeds to step 421; when a change is detected, online transaction process 400 proceeds to step 411.

In step 411, online transaction application 151 stores the changes that were detected to order information in step 405. Thus, in step 411, at least a portion of previously stored order information is updated. In some instances, the previously stored order information includes provisional order information stored in step 402, and in other instances, the previously stored order information includes previously detected changes to order information stored in a previous iteration of step 411.

In step 412, in response to changes being detected to order information in confirmation page 310, online transaction application 151 resets the order modification timer. Thus, a user is not constrained by the duration of the order modification timer and is not rushed when modifying order information. After online transaction application 151 resets the order modification timer, online transaction process 400 returns to step 405.

In step 421, online transaction application 151 determines whether the order modification timer has expired. If no, online transaction process 400 returns to step 405; if yes, online transaction process 400 proceeds to step 422.

In step 422, online transaction application 151 completes the online checkout process requested in step 401 using the saved order information. Thus, the most recent changes made in confirmation page 310 are included in the order information used to complete the online checkout process. In some embodiments, online transaction application 151 completes the online checkout process by completing data fields associated with the click-to-purchase process of merchant website 140 using product information 330 and billing information 340. More specifically, in some embodiments, online transaction application 151 completes the online checkout process with merchant server 130 by transmitting to merchant server 130 the product information, billing information (e.g., credit card primary account number and associated CVV, billing address associated with the primary account number, and user name associated with the primary account number), and shipping information that merchant website 130 requests for the completion of an online purchase by a user. Using the billing information received from online transaction application 151, merchant server 130 then charges the primary account number included therein and begins the process of satisfying the online order. By contrast, in many conventional online purchasing schemes, merchant server 130 does not receive billing information and does not charge a specific user directly.

In some embodiments, the saved order information employed in step 422 may not include all of the product information, billing information, and/or shipping information transmitted to merchant server 130 in step 422. For example, in some embodiments, the stored information includes a portion of such product information, billing information, and/or shipping information, and online transaction application 151 retrieves a remainder portion of such product information, billing information, and/or shipping information when the online checkout process is requested. Thus, in such embodiments, the combination of the stored information and the remainder portion (which is retrieved by online transaction application 151) enables the online checkout process with merchant server 130 to be completed. In one such embodiment, the stored information includes product information associated with the online checkout process initiated via the purchase-with-one-click input interface and a portion of billing information (such as an encrypted CVV for a credit card associated with a particular particular payment method), but no other billing information or shipping information associated with the online checkout process. In the embodiment, the remainder portion includes other billing information (such as an encrypted primary account number for the credit card associated with the particular payment method) and shipping information associated with the particular payment method. Thus, the combination of the stored information and the remainder portion, once decrypted by online transaction application 151, enables the online checkout process with merchant server 130 to be completed and merchant server 130 to charge the primary account number for the credit card associated with the particular payment method.

One technical advantage of online transaction process 400 is that a user can modify order information employed in an online checkout process for a predetermined time interval after a click-to-purchase process has been initiated by a user input via a click-to-purchase input interface (e.g., a transaction button 142). As a result, errors detected by the user or vacillation on the part of a user during the predetermined time interval can be addressed by simply inputting changes to the order information into confirmation page 310 or an equivalent confirmation user interface page. Thus, the user is not required to cancel the online order that was initiated with the click-to-purchase interface to modify the order information. This technical advantage represents one or more technological improvements over prior art approaches.

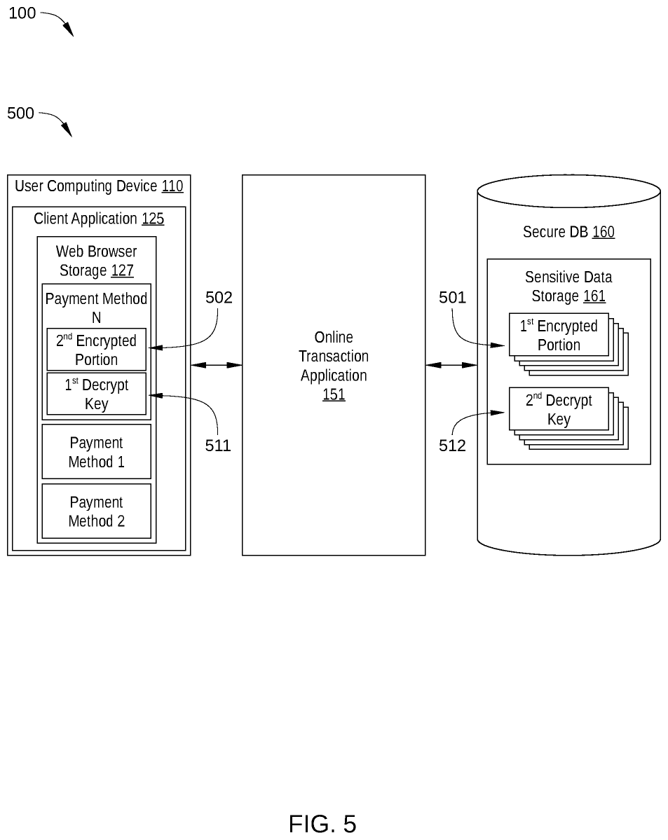

As noted above, in some embodiments, order information that can be modified by a user in online transaction process 400 includes billing information 340. According to some embodiments, such billing information 340 includes a particular payment method that can be selected from multiple payment methods. Thus, in such embodiments, for a particular online checkout process, a user can change from one payment method that is based on a first credit card account to another payment method that is based on a second credit card account. It is noted that there are currently an average of about six credit cards issued in the United States for every household. Embodiments described herein enable a user to easily select a particular payment method from multiple payment methods available to the user for use in a click-to-purchase process. In addition, embodiments described herein enable a user to easily change from one available payment method to another available payment method during a predetermined time interval after a click-to-purchase process has been initiated by the user, greatly enhancing the online shopping experience for the user. One such embodiment is described below in conjunction with FIGS. 5-7.

FIG. 5 is a block diagram illustrating a payment method storage system 500 implemented within online transaction network 100, according to various embodiments. As shown, elements of payment method storage system 500 for a particular user can be implemented with client application 125 and web browser storage 127 of user computing device 110, online transaction application 151, and sensitive data storage 161 within secure database 160.

As shown, N payment methods are available to a user of user computing device 110, although not all information associated with each of the N payment methods is actually stored by user computing device 110. Specifically, for each payment method available to the user, an encrypted portion of credit card information (e.g., second encrypted portion 502), a first decryption key 511, and a payment method identifier are stored in web browser storage 127. In some embodiments, when a request to perform an online checkout process for a particular online purchase is sent to online transaction application 151 and a particular payment method is selected for that online checkout process, information associated with that particular payment method is included in the request for the online checkout process. In some embodiments, such information includes second encrypted portion 502, first decryption key 511, and the payment method identifier for that particular payment method.

In some embodiments, second encrypted portion 502 of the payment method includes the CVV for a primary account number of a credit card but not the primary account number itself. Second encrypted portion 502 is encrypted via a second decryption key 512, which is stored in sensitive data storage 161. First decryption key 511 is configured for encryption of a first encrypted portion 501 of the particular payment method. In some embodiments, first decryption key 511 is a symmetric decryption/encryption key, and is generated via any technically feasible encryption algorithm, such as Golang. The payment method identifier can be any identifier that uniquely differentiates the N payment methods available to a user of user computing device 110.

For each payment method available to the user, certain information associated with the payment method is stored in sensitive data storage 161. In some embodiments, such information includes an encrypted portion of credit card information (e.g., first encrypted portion 501), a second decryption key 512, and a payment method identifier. Second decryption key 512 is configured for encryption of second encrypted portion 502 of the particular payment method. In some embodiments, second decryption key 512 is a symmetric encryption/decryption key, and is generated via any technically feasible encryption algorithm, such as Golang. In some embodiments, first encrypted portion 501 includes a primary account number of a credit card but not the CVV associated with the primary account number. In some embodiments, first encrypted portion 501 further includes additional billing and/or personal identifiable information associated with the particular payment method, such as a card user name associated with the primary account number, a card expiration date associated with the primary account number, the billing address associated with the primary account number, and/or the like. Alternatively, additional billing and/or personal identifiable information associated with the particular payment method is stored in sensitive data storage 161 in unencrypted form, or in a form that does not require decryption with first decryption key 511.

When a request for the online checkout process is received by online transaction application 151, online transaction application 151 can decrypt first encrypted portion 501 based on first decryption key 511 and can decrypt second encrypted portion 502 based on second decryption key 512. Thus, online transaction application 151 can provide to merchant server 130 suitable order information, including sensitive payment method information, based on non-sensitive information included in the request from client application 125 or user computing device 110 for the online checkout process.

In some embodiments, two-layer encryption is employed by online transaction application 151 for the storage of first encrypted portions 501 in sensitive data storage 161 and/or second encrypted portions 502 in web browser storage 127. Some examples of a two-layer encryption scheme as employed in an online transaction network 100 have been discussed in U.S. patent application Ser. No. 16/944,125, filed Jul. 30, 2020, and is incorporated herein in its entirety by reference.

At least one technical advantage of the disclosed embodiments relative to the prior art is that the disclosed embodiments enable a user to change a payment method for an online checkout process that has already been initiated by a user input via a purchase-with-one-click input interface (e.g., a transaction button 142) without canceling the order and repeating the online selection process. That is, in the embodiments, the user is not required to cancel the online order that was initiated with the purchase-with-one-click interface to modify the payment method. Another advantage of the disclosed embodiments is that a user can easily and securely select a payment method for a particular online checkout process when a click-to-purchase process has been initiated by a user input.

In the embodiments described above in conjunction with FIG. 5, information associated with a multiple payment methods are made available to a user to edit a particular click-to-purchase process during an online checkout process. In other embodiments, multiple payment methods that are securely stored between sensitive data storage 161 and web browser storage 127 can be advantageously employed in other applications as well. For example, in some embodiments, embodiments of the multiple payment method storage scheme described above facilitate selection of a payment method in an e-commerce website.

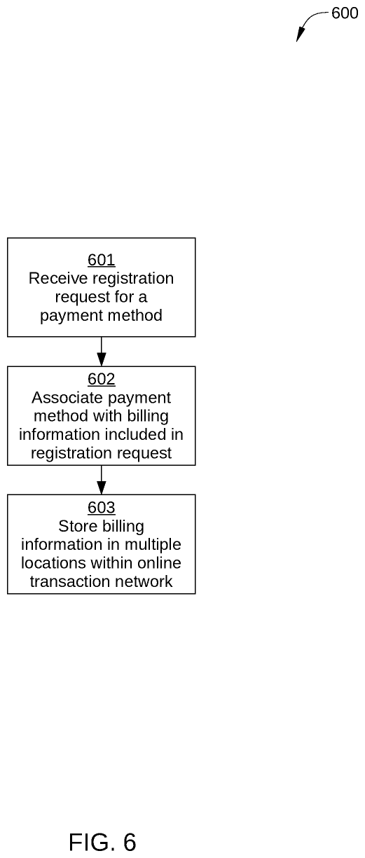

FIG. 6 is a flowchart illustrating the steps performed by online transaction network 100 as part of a payment method registration process 600, according to various embodiments. Payment method registration process 600 may include one or more operations, functions, or actions as illustrated by one or more of blocks 601-603. Although the blocks are illustrated in a specific order, these blocks may be performed in parallel, and/or in a different order than those described herein. Also, the various blocks may be combined into fewer blocks, divided into additional blocks, and/or eliminated based upon a specific implementation. Although the method is described in conjunction with online transaction network 100 of FIG. 1, persons skilled in the art will understand that within the scope of the present disclosure any suitably configured system can perform payment method registration process 600.

Payment method registration process 600 begins at step 601, where online transaction application 151 receives a registration request for a particular payment method. In some embodiments, online transaction application 151 receives the request to register a particular payment method from user computing device 110. For example, in some embodiments, the registration request is transmitted from client application 125 or from web browser 126. In some embodiments, the registration request includes some or all billing information associated with a particular credit card, such as the primary account number, the CVV, the card holder name, the billing address, and the like.

In some embodiments, the registration request is received by online transaction application 151 as part of an online purchase process. Alternatively or additionally, in some embodiments, the registration request is received by online transaction application 151 as part of a registration process. For example, the registration process may be performed by the user via user computing device 110 at a website associated with online transaction application 151 and/or application server 150. Alternatively or additionally, in some embodiments, the registration request is received by online transaction application 151 while user computing device 110 is connected to and/or checkout is performed at an e-commerce website that includes registration logic embedded therein, or is at some other e-commerce website. Alternatively or additionally, in some embodiments, the registration request is received by online transaction application 151 while a shoppable e-mail is opened in web browser 126. Alternatively or additionally, in some embodiments, the registration request is received by online transaction application 151 while user computing device 110 has a shoppable SMS message opened that includes registration logic embedded therein. Alternatively or additionally, in some embodiments, the registration request is received by online transaction application 151 while user computing device 110 has a shoppable social media post opened that includes registration logic embedded therein.

In step 602, online transaction application 151 associates a payment method with the billing information associated with and/or included in the registration request. In some embodiments, the payment method is further associated with a specific website. Thus, in such embodiments, a user can can link a specific payment method to a specific website. In some embodiments, the payment method is further associated with a specific e-commerce environment, such as purchase-with-one-click transactions that occur via a shoppable e-mail, a shoppable SMS message, and/or a shoppable social media post.

In step 603, online transaction application 151 securely stores information for the payment method in multiple locations within online transaction network 100. As described above in conjunction with FIG. 5, in some embodiments, online transaction application 151 stores a first portion of the billing information and a second decryption key in sensitive data storage 161 and a second portion of the billing information and a first decryption key in web browser storage 127. Further, in some embodiments, two-layer encryption can be employed by online transaction application 151 when storing information associated with payment methods.

Upon completion of payment method registration process 600, a specific payment method and associated billing information is available for a user to employ in an online purchase process. In some embodiments, payment method registration process 600 is performed for each payment method to be associated with a particular user on user computing device 110. Thus, in such embodiments, payment method registration process 600 may be performed multiple times by a particular user when the user is to be associated with multiple payment methods.

Payment method registration process 600 provides a secure, encrypted, cloud-based approach for storing and accessing multiple payment methods for a particular user. In addition, a user can link each payment method to one or more specific sites that employ a purchase-with-one-click input interface, so that each payment method is employed on a per-website basis.

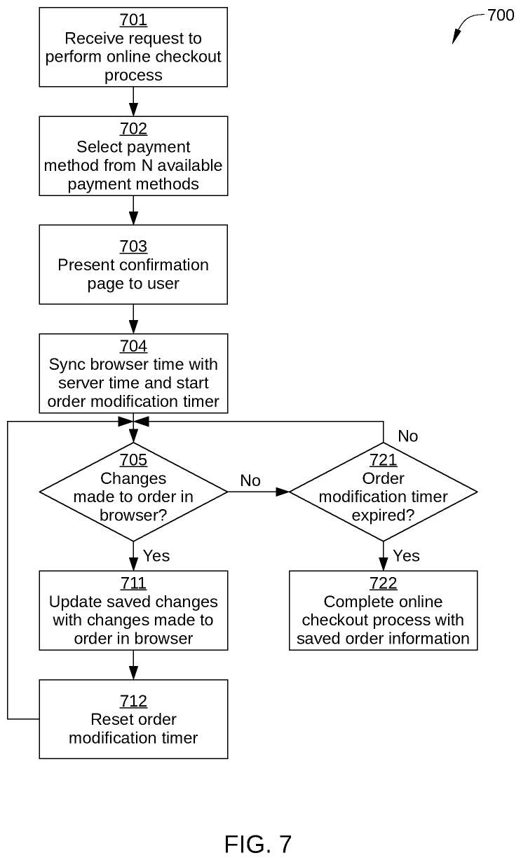

FIG. 7 is a flowchart illustrating the steps performed by online transaction network 100 as part of an online payment process 700, according to various embodiments. Online payment process 700 may include one or more operations, functions, or actions as illustrated by one or more of blocks 701-722. Although the blocks are illustrated in a specific order, these blocks may be performed in parallel, and/or in a different order than those described herein. Also, the various blocks may be combined into fewer blocks, divided into additional blocks, and/or eliminated based upon a specific implementation. Although the method is described in conjunction with online transaction network 100 of FIG. 1, persons skilled in the art will understand that within the scope of the present disclosure any suitably configured system can perform online payment process 700.

Online payment process 700 begins at step 701, where online transaction application 151 receives a request to perform an online checkout process for an online purchase in response to a user input via a transaction button 142, such as a “purchase with one click” button. In some embodiments, the transaction button 142 is included in a web browser 126. Alternatively or additionally, in some embodiments, the transaction button 142 is included in some other e-commerce environment, such as an e-commerce website that includes suitable “purchase with one click” logic coupled to online transaction application 151, a shoppable e-mail that includes such logic, a shoppable SMS message that includes such logic, and/or a shoppable social media post that includes such logic.

In step 702, online transaction application 151 selects a payment method from the N payment methods available to the user of user computing device 110. In some embodiments, online transaction application 151 selects a default payment method from the N payment methods. In one such embodiment, online transaction application 151 selects the default payment method based, for example, on the current e-commerce environment in which the purchase-with-one-click button resides. In another such embodiment, online transaction application 151 selects the default payment method based, for example, on the website that is associated with the purchase-with-one-click button. In some embodiments, online transaction application 151 selects a payment method based on an indicator, such as a payment method identification, that is included in the request to perform an online checkout process. In such embodiments, a user may first select a desired payment method from the N payment methods available prior to performing the input via the purchase-with-one-click button or other interface.

In step 703, online transaction application 151 causes web browser 126 to present a confirmation page 310 to the user on user computing device 110. Generally, confirmation page 310 enables the user to modify one or more portions of the order information associated with the online purchase and includes a current value of an order modification timer, such as timeout counter 360.

In step 704, online transaction application 151 synchronizes browser time with the server time of application server 150 and begins an order modification timer that counts down from a predetermined time. Step 704 may be consistent with step 404 of online transaction process 400 in FIG. 4.

In step 705, online transaction application 151 determines whether a change has been made to order information associated with the request for the online checkout process. Step 705 may be consistent with step 405 of online transaction process 400 in FIG. 4. When no change is detected, online payment process 700 proceeds to step 721; when a change is detected, online payment process 700 proceeds to step 711.

In step 711, online transaction application 151 stores the changes that were detected to order information in step 705. Thus, in step 711, at least a portion of previously stored order information is updated. Step 711 may be consistent with step 411 of online transaction process 400 in FIG. 4.

In step 712, in response to changes being detected to order information in confirmation page 310, online transaction application 151 resets the order modification timer. Step 712 may be consistent with step 412 of online transaction process 400 in FIG. 4. After online transaction application 151 resets the order modification timer, online transaction process 700 returns to step 705.

In step 721, online transaction application 151 determines whether the order modification timer has expired. If no, online transaction process 700 returns to step 705; if yes, online transaction process 700 proceeds to step 722.

In step 722, online transaction application 151 completes the online checkout process requested in step 701 using the saved order information. Thus, the most recent changes made in confirmation page 310 are included in the order information used to complete the online checkout process. Generally, online transaction application 151 completes the online checkout process by completing data fields associated with the click-to-purchase process of merchant website 140 using product information 330 and billing information 340.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method of completing an online checkout process in a network environment including a user computing device, a merchant computing device, and an application computing device, the method comprising:
receiving first order information, by the application computing device, from the user computing device in response to a single user input that requests completion of the online checkout process, wherein the first order information is selected from information provided to the user computing device by the merchant computing device;
determining, by the application computing device, whether the first order information is being modified at the user computing device;
in response to receiving second order information, replacing the first order information with the second order information before sending any order information associated with the online checkout process to the merchant computing device by the application computing device; and
completing the online checkout process, by the application computing device, with the merchant computing device using the second order information.

2. The computer-implemented method of claim 1, further comprising, in response to receiving the first order information, causing the user computing device to present an order confirmation indicator and a change order interface that is configured to receive a user input.

3. The computer-implemented method of claim 2, wherein determining that the first order information is being modified at the user computing device comprises receiving a user input via the change order interface.

4. The computer-implemented method of claim 3, wherein the change order interface includes at least one of an input interface for initiating changing the first order information and a field associated with at least a portion of the first order information.

5. The computer-implemented method of claim 1, further comprising receiving the first order information via a web browser running on the user computing device.

6. The computer-implemented method of claim 1, wherein the change order interface comprises one of a window or an icon presented via a web browser running on the user computing device.

7. The computer-implemented method of claim 1, wherein the order confirmation indicator comprises one of a window or an icon presented via a web browser running on the user computing device.

8. The computer-implemented method of claim 1, wherein completing the online checkout process with the merchant computing device comprises determining a payment method from a plurality of eligible payment methods.

9. The computer-implemented method of claim 8, further comprising providing payment information associated with the payment method to the merchant computing device.

10. The computer-implemented method of claim 8, further comprising, prior to receiving the first order information from the user computing device, storing a first portion of the payment information with the user computing device and storing a second portion of the payment information with the application computing device.

11. The computer-implemented method of claim 1, wherein determining whether the first order information is being modified at the user computing device comprises determining whether the first order information is being modified during a predetermined time interval.

12. The computer-implemented method of claim 11, further comprising pausing completion of the online checkout process for the predetermined time interval after receiving the first order information and before completing the online checkout process with the merchant computing device.

13. The computer-implemented method of claim 1, wherein receiving the second order information for the online checkout process comprises:
causing a confirmation page to be presented by the user computing device; and
receiving the second order information via the confirmation page.

14. The computer-implemented method of claim 9, wherein the online checkout process with the merchant computing device comprises the merchant computing device charging a user associated with the user computing device based on the payment information associated with the payment method.

15. The computer-implemented method of claim 11, further comprising, causing a countdown timer to be presented by the user device that indicates a remaining portion of the predetermined time interval.

16. The computer-implemented method of claim 13, further comprising, in response to receiving the second order information, resetting a predetermined time interval in which completion of the online checkout process is paused.

17. The computer-implemented method of claim 13, further comprising, prior to causing the confirmation page to be presented by the user computing device, synchronizing a first time that is associated with a web browser that presents the confirmation page to a second time that is associated with the application computing device.

18. The computer-implemented method of claim 13, wherein logic associated with the confirmation page is configured to cause the second order information to be received by the application computing device.

19. A non-transitory computer-readable storage medium that includes a set of instructions which, in response to execution by a processor of an application computing device, cause the processor to perform a method for completing an online checkout process in a network environment including a user computing device, a merchant computing device, and the application computing device, the method comprising:
receiving first order information, by the application computing device, from the user computing device in response to a single user input that requests completion of the online checkout process, wherein the first order information is selected from information provided to the user computing device by the merchant computing device;
determining, by the application computing device, whether the first order information is being modified at the user computing device;
in response to receiving second order information, replacing the first order information with the second order information before sending any order information associated with the online checkout process to the merchant computing device by the application computing device; and
completing the online checkout process, by the application computing device, with the merchant computing device using the second order information.

20. The non-transitory computer-readable storage medium of claim 19, wherein completing the online checkout process with the merchant computing device comprises determining a payment method from a plurality of eligible payment methods.
